(19) United States
(12) Patent Application Publication
(10) Pub. No.: US 2014/0263411 A1
(43) Pub. Date: Sep. 18, 2014

(54) Dispensing Ingredients for Use in Recipes

(71) Applicant: The Coca-Cola Company, Atlanta, GA (US)

(72) Inventor: Daniel S. Quartarone, Stone Mountain, GA (US)

(21) Appl. No.: 14/208,323

(22) Filed: Mar. 13, 2014

Related U.S. Application Data
(60) Provisional application No. 61/789,658, filed on Mar. 15, 2013.

(51) Int. Cl. B67D 1/08

(52) U.S. Cl. CPC B67D 1/0888
USPC 222/1; 222/129.1

(57) ABSTRACT

A dispenser is provided which may utilize food or beverage components, finished foods or beverage products, or both, as ingredients when cooking. The dispenser may be configured to provide a graphical user interface from which a user may search either a local or remote database to select a cooking recipe. The dispenser may then be utilized to dispense the appropriate amount of food or beverage components or finished food or beverage products, based on the selected recipe.

### CROSS-REFERENCE TO RELATED APPLICATIONS

This patent application claims priority to U.S. Patent Application Ser. No. 61/789,658, Attorney Docket No. 60428.0014USP1, filed Mar. 15, 2013, entitled “Dispensing Beverage Components For Use As Ingredients In Recipes,” of which the disclosure is incorporated herein, in its entirety, by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Today, many consumers are able to utilize purchased individual ingredient components to make food or beverages without having to buy finished food or beverage products. For example, consumers may be able to individually purchase beverage components such as concentrated syrups and flavoring agents which, along with carbonated water, may be utilized in a dispenser to make carbonated beverages. As another example, consumers may be able to individually purchase food components such as oil and flavor abstracts which may be utilized to make a finished food product. Many cooking recipes also call for the use of food or beverage components and/or finished food or beverage products at various stages (and in varying amounts) during the preparation of various dishes. However, there is currently no capability for a consumer to selectively dispense finished food or beverage products and/or individual food or beverage components so that they may be utilized as recipe ingredients during cooking. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments describe a dispenser which may utilize food or beverage components, finished foods or beverage products, or both, as ingredients when cooking. The dispenser may be configured to provide a graphical user interface from which a user may search either a local or remote database to select a cooking recipe. The dispenser may then be utilized to dispense the appropriate amount of food or beverage components or finished food or beverage products, based on the selected recipe.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for dispensing ingredients for use in a recipe, in accordance with an embodiment;

FIG. 2 is a block diagram illustrating various ingredient types which may be dispensed from the dispensing device in the network architecture of FIG. 1, in accordance with an embodiment;

FIG. 3 is a flow diagram illustrating a routine for dispensing ingredients for use in a recipe, in accordance with an embodiment; and

FIG. 4 is a block diagram illustrating a computing device which may be utilized for dispensing ingredients for use in a recipe, in accordance with an embodiment.

### DETAILED DESCRIPTION

Embodiments describe a dispenser which may utilize food or beverage components, finished foods or beverage products, or both, as ingredients when cooking. The dispenser may be configured to provide a graphical user interface from which a user may search either a local or remote database to select a cooking recipe. The dispenser may then be utilized to dispense the appropriate amount of food or beverage components or finished food or beverage products, based on the selected recipe.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

It should be understood that “beverage,” as used herein, includes, but is not limited to, pulp and pulp-free citrus and non-citrus fruit juices, fruit drinks, vegetable juices, vegetable drinks, milk, soy milk, protein drinks, soy-enhanced drinks, tea, water, isotonic drinks, vitamin-enhanced water, soft drinks, flavored water, energy drinks, coffee, smoothies, yogurt drinks, hot chocolate and combinations thereof. The beverage may also be carbonated or non-carbonated. The beverage may comprise beverage components (e.g., beverage bases, colorants, flavorants, and additives).

The term “beverage base” refers to parts of the beverage or the beverage itself prior to additional colorants, additional flavorants, and/or additional additives. According to certain embodiments of the present invention, beverage bases may include, but are not limited to syrups, concentrates, and the like that may be mixed with a diluent such as still or carbonated water or other diluent to form a beverage. The beverage bases may have reconstitution ratios of about 3:1 to about 6:1 or higher. According to certain embodiments, beverage bases may comprise a mixture of beverage base components.

The term “beverage base component” refers to components which may be included in beverage bases. According to certain embodiments of the present invention, the beverage base component may comprise parts of beverages which may be considered food items by themselves. According to certain embodiments of the present invention, the beverage base components may be micro-ingredients such as an acid portion of a beverage base; an acid-degradable and/or non-acid portion of a beverage base; natural and artificial flavors; flavor additives; natural and artificial colors; nutritive or non-nutritive natural or artificial sweeteners; additives for controlling tartness, e.g., citric acid, potassium citrate; functional additives such as vitamins, minerals, or herbal extracts; nutraceuticals; or medicaments. The micro-ingredients may have reconstitution ratios from about 10:1, 20:1, 30:1, or higher with many having reconstitution ratios of 50:1 to 300:1. The viscosities of the micro-ingredients may range from about 1 to about 100 centipoise.

Thus, for the purposes of requesting, selecting, or dispensing a beverage base, a beverage base formed from separately stored beverage base components may be equivalent to a separately stored beverage base. For the purposes of requesting, selecting or dispensing a beverage, a beverage formed from separately stored beverage components may be equivalent to a separately stored beverage.

By “separately stored” it is meant that the components of the present invention are kept separate until combined. For instance, the components may be separately stored individually in each container or may be all stored in one container wherein each component is individually packaged (e.g., plastic bags) so that they do not blend while in the container. In some embodiments, the container, itself, may be individual, adjacent to, or attached to another container.

The term “blended beverage” includes final products wherein two or more beverages have been blended or mixed or otherwise combined to form a final product.

Referring now to the drawings, in which like numerals represent like elements through the several figures, various aspects of the present invention will be described. FIG. 1 is a block diagram illustrating a network architecture 2 for dispensing ingredients for use in a recipe, in accordance with an embodiment. The network architecture 2 includes a dispensing device 10 in communication with a client computing device 40, a recipe database 60, and a server computing device 70 (over the Internet 50). The dispensing device 10 may comprise store ingredients 14A, 14B, and 14C through 14N. As will be described in greater detail below with respect to FIG. 2, the ingredients 14A-14N may comprise finished beverage products, beverage components, finished food products and/or food components. In accordance with an embodiment, each of the ingredients 14A-14N may be separately stored or contained in individual removable cartridges which are stored in the dispensing device 10. The dispensing machine 10 may automatically identify the cartridges upon installation by a user or the user may be prompted to identify the cartridges when they are installed.

The dispensing device 10 may be configured to generate a graphical user interface (“GUI”) 12 on a display screen (not shown). In accordance with various embodiments and as will be described in greater detail below, the GUI 12 may be utilized to search for and retrieve cooking recipes which utilize one or more of the beverage components and/or finished beverage products dispensed by the dispensing device 10. It should be understood that the recipe database 60, which may include a collection of recipes 62, may comprise a local database which is stored in a memory of the dispensing device 10. In addition to or alternatively to the recipe database 60, the dispensing device 10 may also be configured to retrieve recipes from a remote database. For example, the dispensing device 10 may be configured to connect to the Internet 50 (either directly or via the client computing device 40) in order to communicate with server computing device(s) 70 which may be connected to one or more recipe databases 64 storing recipes 66. Additional functionality of the dispensing device 10 associated with dispensing ingredients for use in a recipe, will be described in greater detail below with respect to FIG. 3. In accordance with various embodiments and as will be described in greater detail below, the GUI 12 may also be utilized to select and individually dispense one or more of the ingredients 14A-14N from the dispensing device 10 apart from the recipes 62 or 66. In some embodiments, the ingredients 14A-14N may be dispensed as one or more selected beverage components in a continuous pour operation (whereby the one or more selected beverage components continue to be dispensed while a pour input is actuated by a user) or in a batch pour operation (whereby a predetermined volume of one or more selected beverage components are dispensed (e.g., one ounce at a time)).

FIG. 2 is a block diagram illustrating various ingredient types which may be dispensed from the dispensing device 10 in the network architecture 2 of FIG. 1, in accordance with an embodiment. As shown in FIG. 2, the ingredient 14A may comprise a finished beverage product 20, one or more beverage components 21, a finished food product 30, or one or more food components 32. In some embodiments, the finished beverage product 20 may comprise a combination (e.g., two or more) of the beverage components 21 and the finished food product 30 may comprise a combination (e.g., two or more) of the food components 32. For example, the finished beverage product 20 may include a combination of beverage base 24, beverage base component 26 and other components 29.

In some embodiments, the beverage components 21 may include partially finished beverage product 22, beverage base 24, beverage base component 26, partially diluted beverage base component 28 and other components 29. In addition to the definition of beverage base and beverage base components above, it should be understood that the partially finished beverage product 22 and partially diluted beverage base component 28 may each comprise a reduced amount of diluent than found in a typical beverage dispense (i.e., in a lesser amount than needed to form a finished beverage product or a beverage base component). It should further be understood that the other components 29 may comprise diluents such as still or carbonated water, functional additives, or medicaments, for example. In some embodiments, the other components 29 may be installed in the dispensing machine 10, pumped to the dispensing machine 10, or both. The carbonated water may be produced in the dispensing device 10 through mixing of CO₂ and still water such as in a carbonator or other device that produces carbonated water. The food components 32 may comprise, in some embodiments, liquid ingredients for producing finished food products (e.g., oil, flavor extracts such as vanilla, almond, etc., or other shelf stable liquid ingredients) which may be pumped from the dispensing device 10. It should be understood that the ingredients 14B-14N may also comprise one of (but not necessarily the same) finished beverage product 20, beverage components 21, finished food product 30 or finished food components 32 as described above with respect to ingredient 14A. Thus, for example, the ingredient 14A may comprise finished beverage product 20, ingredient 14B may comprise one or more beverage components 21 and ingredient 14C may comprise food one or more components 32. Other combinations are also possible.

FIG. 3 is a flow diagram illustrating a routine 300 for dispensing ingredients for use in recipes, in accordance with an embodiment. When reading the discussion of the routines presented herein, it should be appreciated that the logical operations of various embodiments of the present invention are implemented (1) as a sequence of computer implemented acts or program modules running on a computing device or system and/or (2) as interconnected machine logical circuits or circuit modules within the computing device or system. The implementation is a matter of choice dependent on the performance requirements of the computing device or system implementing the invention. Accordingly, the logical operations illustrated in FIG. 3 and making up the various embodiments described herein are referred to variously as operations, structural devices, acts or modules. It will be recognized by one skilled in the art that these operations, structural devices, acts and modules may be implemented in software, in firmware, in hardware, in special purpose digital logical, and any combination thereof without deviating from the spirit and scope of the present invention as recited within the claims set forth herein.

The routine 300 begins at operation 305, where an application executing on the dispensing device 10 may receive a recipe request in the GUI 12. For example, while cooking, a user of the dispensing device 10 may input data into the GUI 12 to search for a particular recipe or recipes for use in preparing meals.

From operation 305, the routine 300 continues to operation 310, where the application executing on the dispensing device 10 may search a database (e.g., recipe databases 60 and/or 64) for the retrieval of recipes in response to the recipe request received at operation 305. In accordance with various embodiments, the dispensing device 10 may either search for recipes in a local database which is stored within its internal memory, in a remote database (or databases) connected to remote servers (e.g., via a direct connection to the Internet 50 or indirectly via the client computing device 40 which is connected to the Internet 50), or both. It should be understood that a user of the dispensing device 10 may also store favorite recipes locally (e.g., on the client computing device 40) or retrieve recipes from the Internet 50 (also through the use of the client computing device 40). It should be appreciated that the remote servers (i.e., the server computing device(s) 70) may be operated and maintained by a food or beverage vendor which supplies the various ingredients utilized in the dispensing device 10.

From operation 310, the routine 300 continues to operation 315, where the application executing on the dispensing device 10 may return search results comprising recipes from one or more of the recipe databases 60 and 64. In accordance with an embodiment, the application may be configured to only return a collection of recipes utilizing ingredients that are available to a user based on currently installed ingredients in the dispensing device 10. For example, if the dispensing device 10 only contains caffeinated concentrated syrups, then the search results would not include recipes utilizing non-caffeinated concentrated syrups as ingredients. In accordance with another embodiment, the application may be configured to return a collection of recipes which include recipes utilizing ingredients that are unavailable to the user (i.e., ingredients which do not correspond to currently installed finished beverage products, finished food products, beverage components or food components in the dispensing device 10) but which may be obtained from third party sources (e.g., a food or beverage vendor). For example, based on the food or beverage ingredients installed in the dispensing device 10, the search results may include suggested recipes which utilize identified food or beverage ingredients unavailable to the user but which the user may install by purchasing them from a food or beverage vendor or other third party source. Thus, in this manner, the dispensing device 10 may facilitate the ordering of unavailable ingredients utilized by the suggested recipes. Furthermore, a user desiring to prepare a recipe utilizing the unavailable ingredients may be motivated to purchase additional ingredients from the food or beverage vendor marketing the dispensing device 10. It should be understood, in accordance with an embodiment, that the client computing device 40 may include an application which allows users to order food or beverage ingredients that they may not have for use in suggested recipes. In accordance with another embodiment, the application may be programmed to configure the dispensing device 10 to allow a user to directly order food or beverage ingredients.

From operation 315, the routine 300 continues to operation 320, where the application executing on the dispensing device 10 may receive a selection of a recipe from the search results returned at operation 315. For example, a user of the dispensing device 10 may select a recipe from a recipe collection displayed on the GUI 12.

From operation 320, the routine 300 continues to operation 325, where the application executing on the dispensing device 10 may display the recipe selected at operation 320 in the GUI 12.

From operation 325, the routine 300 continues to operation 330, where the application 35 executing on the dispensing device 10 may dispense predetermined amounts of ingredients based on the recipe selected at operation 320. In particular, the dispensing device 10 may be configured to dispense individual or combined finished beverage products, beverage components, finished food products and/or food components in quantities called for by a cooking recipe. For example, in some embodiments, the dispensing device 10 may be configured to dispense predetermined amounts of one or more finished beverage products. In other embodiments, the dispensing device 10 may be configured to dispense one or more of a partially finished beverage product, a beverage base, a beverage base component and a partially diluted beverage base component. In other embodiments, the dispensing device 10 may be configured to dispense predetermined amounts of a combination of two or more of a partially finished beverage product, a beverage base, a beverage base component and a partially diluted beverage base component to produce a finished beverage product. In other embodiments, the dispensing device 10 may be configured to dispense a predetermined amount of one or more finished food products. In other embodiments, the dispensing device 10 may be configured to dispense one or more food components. In other embodiments, the dispensing device 10 may be configured to dispense predetermined amounts of a combination of food components to produce a finished food product.

In some embodiments, the dispensing device 10 may also be configured, via the GUI 12, to display instructions which guide a user through preparing the recipe. For example, the dispensing device 10 may be configured to request, via the GUI 12, a container capable of holding a predetermined amount of a first ingredient (e.g., a quarter cup of a beverage base) prior to dispensing the first ingredient. The dispensing device 10 may be configured to await a predetermined delay or await an input, via the GUI 12 or other input device, prior to dispensing the ingredient. Upon receipt of the input, the dispensing device 10 may commence with dispensing the ingredient via a nozzle (not shown). In some embodiments, the dispensing device 10 may dispense an amount of the ingredient specified in the recipe. The input to commence the dispense may be a virtual button on the GUI 12, a virtual button on a separate GUI or display, a physical mechanical or electrical button such as a capacitive touch input, or other input that is used to commence the dispense of ingredients from the dispensing device 10. After the first ingredient has been dispensed, the dispensing device 10 may then request, via the GUI 12, another container capable of holding a subsequent ingredient (e.g., two tablespoons of a vanilla extract) prior to dispensing the subsequent ingredient. It should be appreciated that the application may also configure the dispensing device 10 to wait a predetermined delay or await an input prior to dispensing a predetermined amount of a subsequent ingredient called for by instructions contained in a cooking recipe. In particular, and in accordance with an embodiment, the dispensing device 10 may be configured to function as a timer which may utilized in cooking recipes calling for a delay between the adding of ingredients. For example, if one step of a cooking recipe calls for marinating chicken in a concentrated syrup for one hour, a user may be instructed to signal the dispensing device 10 (e.g., by pressing a button) after the hour has elapsed to indicate that marinating step has been completed at which time the dispensing device 10 may then dispense a subsequent ingredient utilized in the next step of the cooking recipe. It should be appreciated that, in accordance with another embodiment, the application may configure the dispensing device 10 to interface with the client computing device 40 to allow a user to print a recipe. From operation 330, the routine 300 then ends.

FIG. 4 a block diagram illustrating example physical components of the dispensing device 10 with which various embodiments may be practiced. In a basic configuration, the dispensing device 10 may comprise a computing device which includes at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include an operating system 405, an application 407 and the recipe database 60. The operating system 405 may be suitable for controlling the dispensing device 10's operation and the application 407 may comprise functionality for dispensing ingredients for use in a recipe.

The dispensing device 10 may have additional features or functionality. For example, the dispensing device 10 may also include additional data storage devices (not shown) which may be removable and/or non-removable such as, for example, magnetic disks, optical disks, solid state storage devices (“SSD”), flash memory or tape. The dispensing device 10 may also have input device(s) 412 such as a keyboard, a mouse, a pen, a sound input device (e.g., a microphone), a touch input device, etc. Output device(s) 414 such as a display, speakers, a printer, etc. may also be included. The aforementioned devices are examples and others may be used. Communication connection(s) 416 may also be included and utilized to connect to the Internet (or other types of networks) as well as to remote computing systems.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information (such as computer readable instructions, data structures, program modules, or other data) in hardware. The system memory 404 is an example of computer storage media (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the dispensing device 10. Any such computer storage media may also be part of the dispensing device 10.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Various embodiments are described above with reference to block diagrams and/or operational illustrations of methods, systems, and computer program products. The operations/acts noted in the blocks may be skipped or occur out of the order as shown in any flow diagram. For example, two or more blocks shown in succession may in fact be executed substantially concurrently or the blocks may sometimes be executed in the reverse order, depending upon the functionality/acts involved.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method of dispensing ingredients for use in a recipe, comprising:
receiving a recipe request in a user interface generated by a dispensing device;
searching, by the dispensing device, a database for the recipe request;
returning, by the dispensing device, one or more search results in response to the search request;
receiving a selection of a recipe from the one or more search results, the selected recipe utilizing one or more of the ingredients; and
dispensing a predetermined amount of the one or more of the ingredients from the dispensing device based on the selected recipe.

2. The method of claim 1, wherein dispensing a predetermined amount of the one or more of the ingredients from the dispensing device based on the selected recipe comprises dispensing predetermined amounts of one or more finished beverage products.

3. The method of claim 1, wherein dispensing a predetermined amount of the one or more of the ingredients from the dispensing device based on the selected recipe comprises dispensing predetermined amounts of one or more of a partially finished beverage product, a beverage base, a beverage base component and a partially diluted beverage base component.

4. The method of claim 1, wherein dispensing a predetermined amount of the one or more of the ingredients from the dispensing device based on the selected recipe comprises combining predetermined amounts two or more of a partially finished beverage product, a beverage base, a beverage base component and a partially diluted beverage base component to produce a finished beverage product.

5. The method of claim 1, wherein dispensing a predetermined amount of the one or more of the ingredients from the dispensing device based on the selected recipe comprises dispensing a predetermined amount of one or more finished food products.

6. The method of claim 1, wherein dispensing a predetermined amount of the one or more of the ingredients from the dispensing device based on the selected recipe comprises dispensing predetermined amounts of one or more food components.

7. The method of claim 1, dispensing a predetermined amount of the one or more of the ingredients from the dispensing device based on the selected recipe comprises combining a plurality of food components to produce a finished food product.

8. An apparatus for dispensing ingredients for use in a recipe, comprising:
a memory for storing executable program code; and
a processor, functionally coupled to the memory, the processor being responsive to computer-executable instructions contained in the program code and operative to:
receive a recipe request in a user interface;
search a database for the recipe request;
return one or more search results in response to the search request;
receive a selection of a recipe from the one or more search results, the selected recipe utilizing one or more of the ingredients; and
dispense a predetermined amount of the one or more of the ingredients based on the selected recipe.

9. The apparatus of claim 7, wherein the ingredients comprise one or more finished beverage products.

10. The apparatus of claim 7, wherein the ingredients comprise one or more of a partially finished beverage product, a beverage base, a beverage base component and a partially diluted beverage base component.

11. The apparatus of claim 7, wherein the selected recipe comprises a combination of predetermined amounts of two or more of a partially finished beverage product, a beverage base, a beverage base component and a partially diluted beverage base component which form a finished beverage product.

12. The apparatus of claim 7, wherein the ingredients comprise one or more finished food products.

13. The apparatus of claim 7, wherein the ingredients comprise one or more food components.

14. The apparatus of claim 7, wherein the selected recipe comprises a combination of predetermined amounts of a plurality of food components which form a finished food product.

15. A computer-readable storage medium storing computer executable instructions which, when executed by a computing device, will cause the computing device to perform a method of dispensing ingredients for use in a cooking recipe, the method comprising:
receiving a recipe request in a user interface;
searching a database for the recipe request;
returning, by the dispensing device, one or more search results in response to the search request;
receiving a selection of a recipe from the one or more search results, the selected recipe utilizing one or more of the ingredients; and
dispensing a predetermined amount of the one or more of the ingredients from the dispensing device based on the selected recipe.

16. The computer-readable storage medium of claim 15, wherein dispensing a predetermined amount of the one or more of the ingredients from the dispensing device based on the selected recipe comprises dispensing predetermined amounts of one or more finished beverage products.

17. The computer-readable storage medium of claim 15, wherein dispensing a predetermined amount of the one or more of the ingredients from the dispensing device based on the selected recipe comprises dispensing predetermined amounts of one or more of a partially finished beverage product, a beverage base, a beverage base component and a partially diluted beverage base component.

18. The computer-readable storage medium of claim 15, wherein dispensing a predetermined amount of the one or more of the ingredients from the dispensing device based on the selected recipe comprises combining predetermined amounts two or more of a partially finished beverage product, a beverage base, a beverage base component and a partially diluted beverage base component to produce a finished beverage product.

19. The computer-readable storage medium of claim 15, wherein dispensing a predetermined amount of the one or more of the ingredients from the dispensing device based on the selected recipe comprises dispensing a predetermined amount of one or more finished food products.

20. The computer-readable storage medium of claim 15, wherein dispensing a predetermined amount of the one or more of the ingredients from the dispensing device based on the selected recipe comprises dispensing predetermined amounts of one or more food components.

21. The computer-readable storage medium of claim 15, dispensing a predetermined amount of the one or more of the ingredients from the dispensing device based on the selected recipe comprises combining a plurality of food components to produce a finished food product.
